(19) United States
(12) Patent Application Publication
(10) Pub. No.: US 2025/0294553 A1
(43) Pub. Date: Sep. 18, 2025

(54) EXTEND SYSTEM INFO BROADCAST RESOURCE BLOCK NUMBER FOR REDUCED CAPABILTIES ENHANCEMENT COVERAGE

(71) Applicant: Nokia Technologies Oy, Espoo (FI)

(72) Inventors: Jie GAO, Hangzhou (CN); Gilsoo LEE, Naperville, IL (US); Rapeepat RATASUK, Naperville, IL (US)

(21) Appl. No.: 18/860,446

(22) PCT Filed: Apr. 27, 2022
(86) PCT No.: PCT/CN2022/089669

§ 371 Date: Oct. 25, 2024

(51) Int. Cl. H04W 72/1273; H04W 72/0453; H04W 72/0457; H04W 72/20

(52) U.S. Cl. CPC H04W 72/1273; H04W 72/0453; H04W 72/0457; H04W 72/20

(57) ABSTRACT

Example embodiments of the invention provide at least a method and apparatus to perform receiving, by a terminal device and from a network node of a radio access network, control information for a physical downlink shared channel message or transmission, wherein the control information indicates if a number of resource blocks scheduled by the network node for the PDSCH message or transmission is extendable in frequency domain; and receiving the physical downlink shared channel message or transmission based on the control information; and determining, by a network node, control information for a physical downlink shared channel message or transmission to a terminal device, wherein the control information indicates if a number of resource blocks scheduled by the network node for the PDSCH message or transmission is extendable in a frequency domain; and sending the physical downlink shared channel message or transmission to the terminal device based on the control information.

### TECHNICAL FIELD

The teachings in accordance with the example embodiments of this disclosure relate generally to configuration of a control resource set and, more specifically, relate to configuration to expand a number or resource blocks of a control resource set such as to enhance downlink coverage for a reduced capability terminal device.

### BACKGROUND

This section is intended to provide a background or context to the disclosure that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Reduced capabilities (REDCAP) objectives include and specify NR-based radio access for cellular internet of things in FRI frequency ranges, such as for 5G, that addresses very low device cost, low device power consumption, improved indoor coverage, new use cases and support for massive number of devices.

Requirements include:

| | |
|---|---|
| 1) | Device complexity comparable to LTE Cat-1 / Cat-1bis device, |
| 3) | Low power consumption, |
| 4) | Support for massive number of devices, and |
| 5) | Support for 5GC (Core network) |

Example embodiments of the disclosure work to improve and enhance at least power consumption and coverage for REDCAP user equipment.

Certain abbreviations that may be found in the description and/or in the Figures are herewith defined as follows:
BW bandwidth
BWP bandwidth part
CORESET control resource set
CRB common resource block
DL downlink
DMRS demodulation reference signal
UL uplink
gNB next generation Node B
MIB master info broadcast
NR new radio
PDCCH physical downlink control channel
PDSCH physical downlink shared channel
PRB physical resource block
RB resource block
REDCAP reduced capabilities
RIV resource indicator value
SCS sub carrier space
SIB system info broadcast
SSB synchronization signal block
SI-RNTI system information-radio network temporary identifier
TBS transport block size

### SUMMARY

This section contains examples of possible implementations and is not meant to be limiting.

In an example aspect of the disclosure, there is an apparatus, such as a network side apparatus, includes: at least one processor; and at least one non-transitory memory including computer program code, where the at least one memory and the computer program code are configured, with the at least one processor, to cause the apparatus to at least: receive, by a terminal device and from a network node of a radio access network, control information for a physical downlink shared channel (PDSCH) message or transmission, wherein the control information indicates if a number of resource blocks scheduled by the network node for the physical downlink shared channel message or transmission is extendable in a frequency domain; and receive the physical downlink shared channel message or transmission based on the control information.

In another example aspect of the disclosure, there is a method including the steps of: receiving, by a terminal device and from a network node of a radio access network, control information for a physical downlink shared channel (PDSCH) message or transmission, wherein the control information indicates if a number of resource blocks scheduled by the network node for the physical downlink shared channel message or transmission is extendable in a frequency domain; and receiving the physical downlink shared channel message or transmission based on the control information.

A further example embodiment is an apparatus and a method of the previous paragraphs, wherein the physical downlink shared channel message or transmission includes a system information broadcast message, and the physical downlink shared channel message or transmission includes a system information broadcast message, and the control information includes a resource indication value indicative of if the number of scheduled resource blocks is extendable in the frequency domain, wherein the number of scheduled resource blocks is determined based on at least a portion of a system bandwidth or bandwidth part (BWP) configured in the radio access network, wherein the number of scheduled resource blocks is extended if the at least the portion of the system bandwidth or bandwidth part is equal to a pre-defined value; and wherein the number of scheduled resource blocks is not extended if the at least the portion of the system bandwidth or bandwidth part is greater than the pre-defined value, wherein the pre-defined value for the system bandwidth is 5 MHz or the number of scheduled resource blocks in the bandwidth part is 25 resource blocks, wherein the number of scheduled resource blocks is extended beyond the pre-defined value, wherein the number of scheduled resource blocks is extended beyond the pre-defined value, wherein the number of scheduled resource blocks beyond the pre-defined value is extended into a guard band associated with the system bandwidth or bandwidth part, wherein the extended number of scheduled resource blocks beyond the pre-defined value is extended without engaging a guard band associated with the system bandwidth or bandwidth part, wherein the extended number of scheduled resource blocks beyond the pre-defined value being one of: data in a repeated and copied resource blocks in the physical downlink shared channel message or transmission, wherein extended resource blocks into the guard band are repeated by selecting from a start at one end of the number of scheduled resource blocks of the system information broadcast message in a wrap-around manner, wherein the extended number of scheduled resource blocks comprise a demodulation reference signal sequence associated with the system information broadcast message to allow the terminal device to directly combine with the extended resource blocks, wherein the extended number of scheduled resource blocks include a demodulation reference signal sequence associated with the system information broadcast message to allow the terminal device to directly combine with the extended resource blocks, wherein there is, when the extended resource blocks engaged in the guard band, checking for presence of a demodulation reference signal matching in the extended resource blocks prior to the combining of the extended resource blocks, wherein the demodulation reference signal is associated with the system information broadcast message, wherein the demodulation reference signal is used with at least one of the extended resource blocks without engaging the guard band.

A non-transitory computer-readable medium storing program code, the program code executed by at least one processor to perform at least the method as described in the paragraphs above.

In another example aspect of the disclosure, there is an apparatus including: means for receiving, by a terminal device and from a network node of a radio access network, control information for a physical downlink shared channel (PDSCH) message or transmission, wherein the control information indicates if a number of resource blocks scheduled by the network node for the physical downlink shared channel message or transmission is extendable in a frequency domain; and means for receiving the physical downlink shared channel (PDSCH) message or transmission based on the control information.

In accordance with the example embodiments as described in the paragraph above, at least the means for receiving and indicating includes a network interface, and computer program code stored on a computer-readable medium and executed by at least one processor.

In another example aspect of the disclosure, there is an apparatus, such as a network side apparatus, includes: at least one processor; and at least one non-transitory memory including computer program code, where the at least one memory and the computer program code are configured, with the at least one processor, to cause the apparatus to at least: determine, by a network node of a radio access network, control information for a physical downlink shared channel (PDSCH) message or transmission to a terminal device, wherein the control information indicates if a number of resource blocks scheduled by the network node for the physical downlink shared channel message or transmission is extendable in a frequency domain; and send the physical downlink shared channel message or transmission to the terminal device based on the control information.

In another example aspect of the disclosure, there is a method including the steps of: determining, by a network node of a radio access network, control information for a physical downlink shared channel (PDSCH) message or transmission to a terminal device, wherein the control information indicates if a number of resource blocks scheduled by the network node for the physical downlink shared channel message or transmission is extendable in a frequency domain; and sending the physical downlink shared channel message or transmission to the terminal device based on the control information.

A further example embodiment is an apparatus and a method of the previous paragraphs, wherein the physical downlink shared channel message or transmission comprises a system information broadcast message, and the control information comprises a resource indication value indicative of if the number of scheduled resource blocks is extendable in the frequency domain, wherein the number of scheduled resource blocks is determined based on at least a portion of a system bandwidth or bandwidth part (BWP) configured in the radio access network, wherein the number of scheduled resource blocks is extended if the at least the portion of the system bandwidth or bandwidth part is equal to a pre-defined value; wherein the number of scheduled resource blocks is not extended if the at least the portion of the system bandwidth or bandwidth part is greater than the pre-defined value, wherein the pre-defined value is 5 MHz or the number of scheduled resource blocks is 25 resource blocks and the number of scheduled resource blocks is extended beyond the pre-defined value, wherein the number of scheduled resource blocks beyond the pre-defined value is extended into a guard band associated with the bandwidth or bandwidth part, wherein the number of scheduled resource blocks beyond the pre-defined value is extended into a guard band associated with the system bandwidth or bandwidth part, and/or wherein the number of scheduled resource blocks beyond the pre-defined value is extended without engaging a guard band associated with the system bandwidth or BWP.

A non-transitory computer-readable medium storing program code, the program code executed by at least one processor to perform at least the method as described in the paragraphs above.

In another example aspect of the disclosure, there is an apparatus includes: means for determining, by a network node of a radio access network, control information for a physical downlink shared channel (PDSCH) message or transmission to a terminal device, wherein the control information indicates if a number of resource blocks scheduled by the network node for the physical downlink shared channel message or transmission is extendable in a frequency domain; and means for sending the physical downlink shared channel message or transmission to the terminal device based on the control information.

In accordance with the example embodiments as described in the paragraph above, at least the means for determining, indicating, and sending includes a network interface, and computer program code stored on a computer-readable medium and executed by at least one processor.

A communication system includes the network side apparatus and the user equipment side apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows reduced capability devices versus other devices;

FIG. 2 shows an example of using a pre-defined bandwidth (BW) value of 5 MHz with a maximum number of 24 resource blocks (RBs) for an initial bandwidth part (BWP);

FIG. 3 shows a set of resource blocks and slot symbols of CORESET for Type0-PDCCH search space set when {SS/PBCH block, PDCCH}SCS is {15, 15} kHz for frequency bands with a minimum channel bandwidth 5 MHz or 10 MHz;

FIG. 4 shows an embodiment of extended resource block (RB) content using guard band for a system information broadcast message (SIB1);

FIG. 5 shows an embodiment of extended number of resource block (RB) content without using guard band for the system information broadcast message (SIB1);

FIG. 6 shows extended RB content in accordance with example embodiments of the disclosure that is same with a starting resource blocks RB0 and 1;

FIG. 7 shows extended RB content in accordance with example embodiments of the disclosure that is same with the starting resource block RB0;

FIG. 8 shows one proposed system diagram in accordance with example embodiments of the disclosure;

FIG. 9 shows a high level block diagram of various devices used in carrying out various aspects of the disclosure; and

FIG. 10A and FIG. 10B each show a method in accordance with example embodiments of the disclosure which may be performed by an apparatus.

### DETAILED DESCRIPTION

Example embodiments of the disclosure relate to at least a method and apparatus to provide capabilities such as to expand a number or resource blocks (RBs) of a control resource set such as to enhance downlink coverage for a reduced capability terminal device.

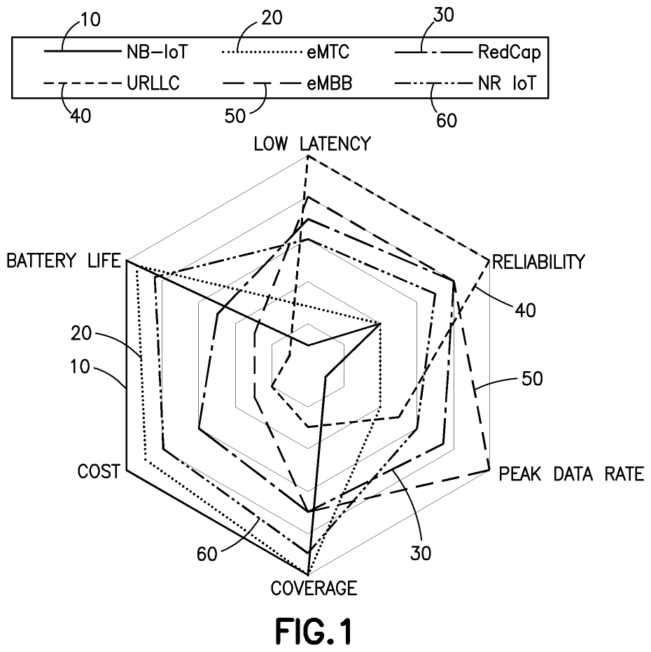

FIG. 1 shows reduced capability devices versus other devices. As shown in FIG. 1 there are lines for 10 narrow band Internet of Things (NB-Iot), 20 eMTC, 30 REDCAP, 40 URLLC, 50 eMBB, and 60 NR IoT shown on an outline for providing services including Battery Life, Low Latency, Reliability, Peak Data Rate, Coverage, and Cost.

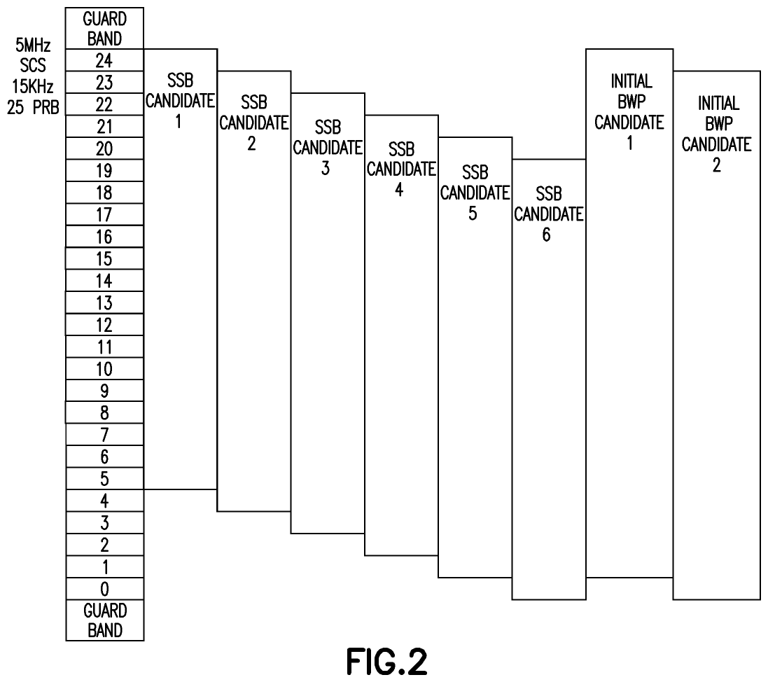

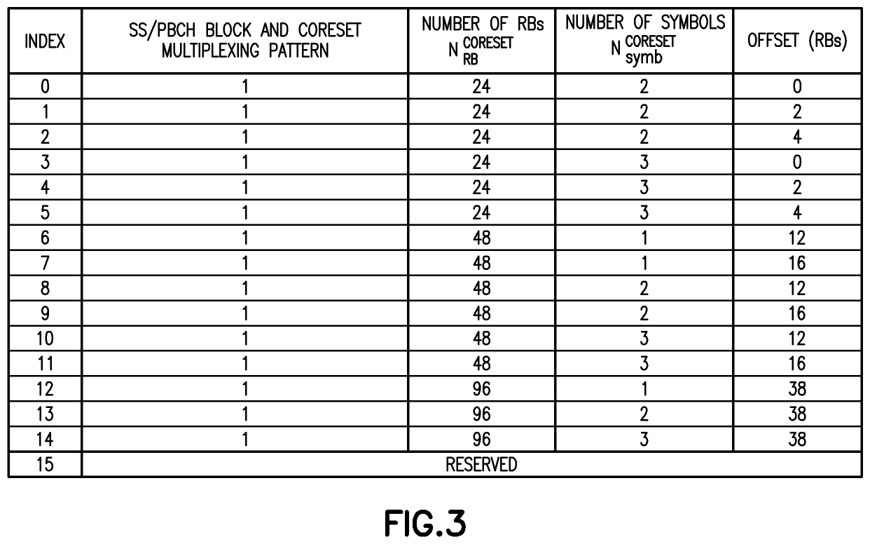

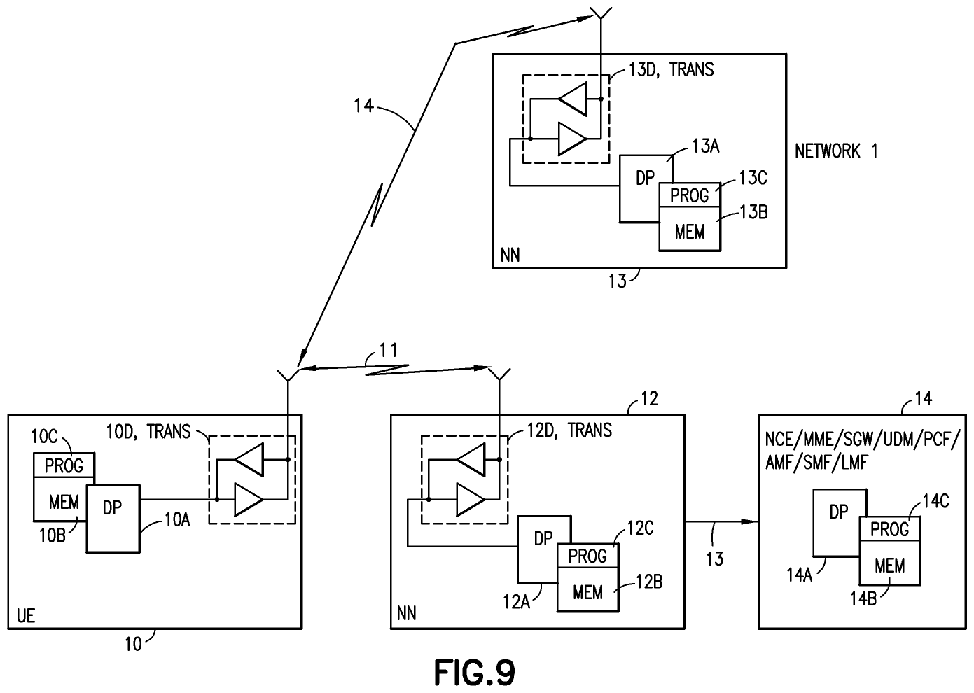

Based on new radio technology for 5 MHz bandwidth with 15 kHz SCS, the max RB numbers are 25 and the initial bandwidth part (BWP) max is 24 RBs based on the control resource set configuration. So at least 1 RB resource may be wasted (that is, cannot be used) for downlink coverage. An example of such waste of 1 RB may be illustrated with an example of a terminal device (e.g., user equipment) after powering up situation or when acquiring for a connection with a radio network (see FIG. 9) with below sequence of steps in a time sequence:
1) Downlinked synchronization signal block (SSB) position (which may carry Master information Broadcast (MIB)) may have six candidate position such as shown in FIG. 2, where FIG. 2 shows a diagram of 24 resource blocks for an initial bandwidth part based on an example using a bandwidth of 5 MHz carrier or a bandwidth part with sub carrier space (SCS) at 15 KHz with 25 physical resource blocks (PRBs), where this sub carrier space includes guard bands on both ends of the resource blocks for interference reduction. Following the synchronization steps by the SSB candidates 1-6 are the downlinking of control information e.g., Control Resource Set (CORESET) 0 for one or more physical downlink shared channel (PDSCH) messages in order to configure an initial band-width part (BWP) candidate1 and an initial BWP candidate2;
2) The received Control Resource Set (CORESET) 0 may be configured based on technical standards 38.213, Table 13-1 (see FIG. 3), which shows a mapping set of resource blocks and slot symbols of CORESET for Type0-physical downlink control channel (PDCCH) search space set. For illustration, when {synchronization signal/physical broadcast channel (SS/PBCH) block, physical downlink control channel (PDCCH)}sub carrier space (SCS) may be {15, 15}kHz for frequency bands with minimum channel bandwidth (BW) 5 MHz or 10 MHz as in FIG. 3. Index 0-5 may be used in 5 MHz BW, where as shown in FIG. 3 there is for each of the indexes 0-15 a number of resource blocks and a number of slot symbols of CORESET for Type0-PDCCH search space set. It is noted that these SS/PBCH block and CORESET multiplexing patterns can be when {SS/PBCH block, PDCCH}SCS is {15, 15}kHz for frequency bands with minimum channel bandwidth 5 MHz or 10 MHz;
3) It is shown in FIG. 2 that the CORESET 0 position may have two candidates. The size of initial DL (downlink) bandwidth part (BWP) of CORESET 0 is not configured for the cell. Nevertheless, the control information in the CORESET 0 may be utilized for New Radio Standalone (NR SA) scenario) introduced in technical standards 38.212.
   The downlink control information format (DCI format 1_0) in the CORESET 0 may be determined and monitored in a common search space according to clause 7.3.1.2.1, where N_{RB}^{DL,BWP} is given by anyone of:
the size of CORESET 0 (if CORESET 0 is configured for the cell); or
the size of initial downlink (DL) bandwidth part (if the CORESET 0 is not configured for the cell), and the size of initial DL bandwidth part (if CORESET 0 is not configured for the cell); and
4) a system information broadcast message (SIB1) may be decoded from the CORESET and used in the initial BWP, so the maximum number of physical resource blocks (PRBs) or resource blocks (RBs) in the SIB1 is 24 in 5 MHz BW with SCS 15 kHz.

Various embodiments of the disclosure may be implemented to user equipment (UEs) with reduced capabilities (REDCAP) by extending (i.e., increasing) a number of downlink physical resource blocks (DL PRBs) beyond the maximum limit of 24 RBs under the same configuration of 5 MHz BW with SCS 15 kHz.

Before describing the example embodiments of the disclosure in detail, reference is made to FIG. 9 for illustrating a simplified system block diagram of various electronic devices that are suitable for use in practicing the example embodiments of this disclosure.

FIG. 9 shows a block diagram of one possible and non-limiting exemplary system in which the example embodiments of the disclosure may be practiced. In FIG. 9, a terminal device, such as user equipment (UE) 10 which may be in wireless communication with a wireless network 1 or network, 1 as in FIG. 9. The wireless network 1 or network 1 as in FIG. 9 may include a communication network such as a mobile network e.g., the mobile network 1 or first mobile network as disclosed herein. Any reference herein to a wireless network 1 as in FIG. 9 may be seen as a reference to any wireless network as disclosed herein. Further, the wireless network 1 as in FIG. 9 may also include hardwired features as may be required by a communication network. A UE is a wireless, typically mobile device that may access a wireless network. The UE, for example, may be a mobile phone (or called a “cellular” phone) and/or a computer with a mobile terminal function. For example, the UE or mobile terminal may also be a portable, pocket, handheld, computer-embedded or vehicle-mounted mobile device and performs a language signaling and/or data exchange with the RAN.

The UE 10 includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which may be optionally connected to one or more antennas for communication to network nodes (NN 12 and NN 13), respectively. The one or more memories MEM 10B include computer program code PROG 10C. The UE 10 communicates with NN 12 and/or NN 13 via a wireless link 11.

The NN 12 (NR/5G Node B, an evolved NB, or LTE device) may be a network node such as a master or secondary node base station (e.g., for NR or LTE long term evolution) that communicates with devices such as NN 13 and UE 10 of FIG. 9. The NN 12 provides access to wireless devices such as the UE 10 to the wireless network 1. The NN 12 includes one or more processors DP 12A, one or more memories MEM 12B, and one or more transceivers TRANS 12D interconnected through one or more buses. In accordance with the example embodiments these TRANS 12D may include X2 and/or Xn interfaces for use to perform the example embodiments of the disclosure. Each of the one or more transceivers TRANS 12D includes a receiver and a transmitter. The one or more transceivers TRANS 12D may be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the NN 13 such as via link 14. Further, the link 11, link 14 and/or any other link may be wired or wireless or both and may implement, e.g., an X2 or Xn interface. Further the link 11 and/or link 14 may be through other network devices such as, but not limited to an NCE/MME/SGW/UDM/PCF/AMF/SMF/LMF 14 device as in FIG. 9. The NN 12 may perform functionalities of an MME (Mobility Management Entity) or SGW (Serving Gateway), such as a User Plane Functionality, and/or an Access Management functionality for LTE and similar functionality for 5G.

The NN 13 may be associated with a mobility function device such as an AMF or SMF, further the NN 13 may include a NR/5G Node B or possibly an evolved NB a base station such as a master or secondary node base station (e.g., for NR or LTE long term evolution) that communicates with devices such as the NN 12 and/or UE 10 and/or the wireless network 1. The NN 13 includes one or more processors DP 13A, one or more memories MEM 13B, one or more network interfaces, and one or more transceivers TRANS 13D interconnected through one or more buses. In accordance with the example embodiments these network interfaces of NN 13 may include X2 and/or Xn interfaces for use to perform the example embodiments of the disclosure. Each of the one or more transceivers TRANS 13D includes a receiver and a transmitter that may optionally be connected to one or more antennas. The one or more memories MEM 13B include computer program code PROG 13C. For instance, the one or more memories MEM 13B and the computer program code PROG 13C are configured to cause, with the one or more processors DP 13A, the NN 13 to perform one or more of the operations as described herein. The NN 13 may communicate with another mobility function device and/or eNB such as the NN 12 and the UE 10 or any other device using, e.g., link 11 or link 14 or another link. The Link 14 as shown in FIG. 9 may be used for communication between the NN 12 and the NN 13. These links maybe wired or wireless or both and may implement, e.g., an X2 or Xn interface. Further, as stated above the link 11 and/or link 14 may be through other network devices such as, but not limited to an NCE/MME/SGW device such as the NCE/MME/SGW/UDM/PCF/AMF/SMF/LMF 14 of FIG. 9.

The one or more buses of the device of FIG. 9 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and these devices may include one or more buses that could be implemented in part as fiber optic cable to connect the other elements of the NN 12 to a RRH.

It is noted that although FIG. 9 shows a network nodes such as NN 12 and NN 13, any of these nodes may incorporate or be incorporated into an eNodeB or eNB or gNB such as for LTE and NR, and would still be configurable to perform example embodiments of the disclosure.

Also, it is noted that description herein indicates that “cells” perform functions, but it should be clear that the gNB that forms the cell and/or a user equipment and/or mobility management function device that will perform the functions. In addition, the cell makes up part of a gNB, and there may be multiple cells per gNB.

The wireless network 1 or any network it may represent may or may not include a NCE/MME/SGW/UDM/PCF/AMF/SMF/LMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management Function (AMF) functionality, and/or Session Management (SMF) functionality, and/or Location Management Function (LMF), and/or Authentication Server (AUSF) functionality and which provides connectivity with a further network, such as a telephone network and/or a data communications network (e.g., the Internet), and which is configured to perform any 5G and/or NR operations in addition to or instead of other standard operations at the time of this application. The NCE/MME/SGW/UDM/PCF/AMF/SMF/LMF 14 is configurable to perform operations in accordance with example embodiments of the disclosure in any of an LTE, NR, 5G and/or any standards based communication technologies being performed or discussed at the time of this application. In addition, it is noted that the operations in accordance with example embodiments of the disclosure, as performed by the NN 12 and/or NN 13, may also be performed at the NCE/MME/SGW/UDM/PCF/AMF/SMF/LMF 14.

The NCE/MME/SGW/UDM/PCF/AMF/SMF/LMF 14 includes one or more processors DP 14A, one or more memories MEM 14B, and one or more network interfaces (N/W I/F(s)), interconnected through one or more buses coupled with the link 13 and/or 14. In accordance with the example embodiments these network interfaces may include X2 and/or Xn interfaces for use to perform the example embodiments of the disclosure. The one or more memories MEM 14B include computer program code PROG 14C. The one or more memories MEM 14B and the computer program code PROG 14C are configured to, with the one or more processors DP 14A, cause the NCE/MME/SGW/UDM/PCF/AMF/SMF/LMF 14 to perform one or more operations which may be needed to support the operations in accordance with the example embodiments of the disclosure.

It is noted that that the NN 12 and/or NN 13 and/or UE 10 may be configured (e.g., based on standards implementations etc.) to perform functionality of a Location Management Function (LMF). The LMF functionality may be embodied in either of the Content Consumer A, Content Consumer B, Dash Server, and/or Content Provider or may be part of these network devices or other devices associated with these devices. In addition, an LMF such as the LMF of the MME/SGW/UDM/PCF/AMF/SMF/LMF 14 of FIG. 9, as at least described below, may be co-located with UE 10 such as to be separate from the NN 12 and/or NN 13 of FIG. 9 for performing operations in accordance with example embodiments of the disclosure as disclosed herein.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP 10, DP 12A, DP 13A, and/or DP 14A and memories MEM 10B, MEM 12B, MEM 13B, and/or MEM 14B, and also such virtualized entities create technical effects.

The computer readable memories MEM 12B, MEM 13B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, and MEM 14B may be means for performing storage functions. The processors DP 10, DP 12A, DP 13A, and DP 14A may be of any type suitable to the local technical environment, and may include one or more of general purpose computers, special purpose computers, microprocessors, digital signal processors (DSPs) and processors based on a multi-core processor architecture, as non-limiting examples. The processors DP 10, DP 12A, DP 13A, and DP 14A may be means for performing functions, such as controlling the UE 10, NN 12, NN 13, and other functions as described herein.

As similarly stated above, example embodiments of the disclosure enhance downlink coverage of UEs with REDCAP by increasing the number of downlink physical resource blocks.

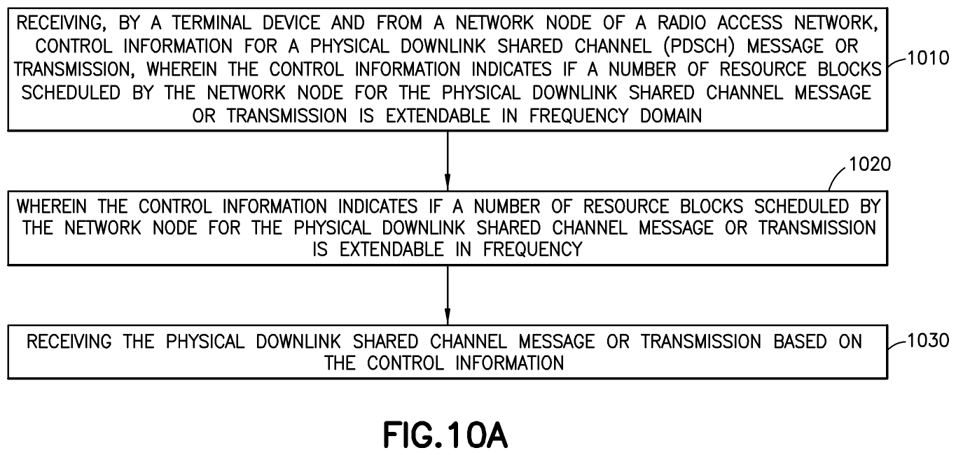

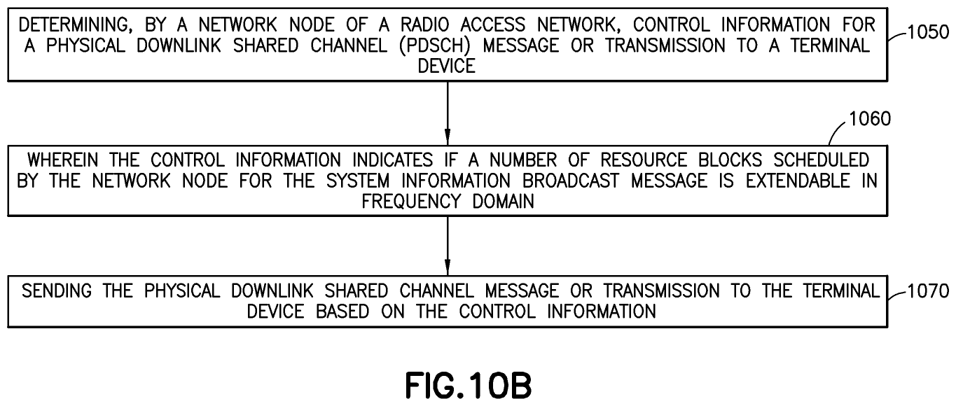

Based on the 3GPP specifications at the time of this application, a 5 MHz bandwidth may only use a pre-defined maximum of 24 RBs for SIB1, and the present disclosure may extend beyond the pre-defined maximum number of 24 RBs to 25 or 26 RBs, thereby enhancing downlink coverage for REDCAP UE. In implementation, this method may be applicable to extend beyond much higher maximum number of RBs using other higher BWP (e.g., 10 MHz, 30 MHz, etc.) and wider sub carrier space (SCS) (e.g., 30 kHz). The configuration of the CORESET 0 to extend beyond the pre-defined maximum number of 24 RBs to 25 or 26 RB in the downlink coverage may be carried out by a network node in a radio network the UE is synchronized and connected to, such as a base station or a gNB (see NN 12 in FIG. 10).

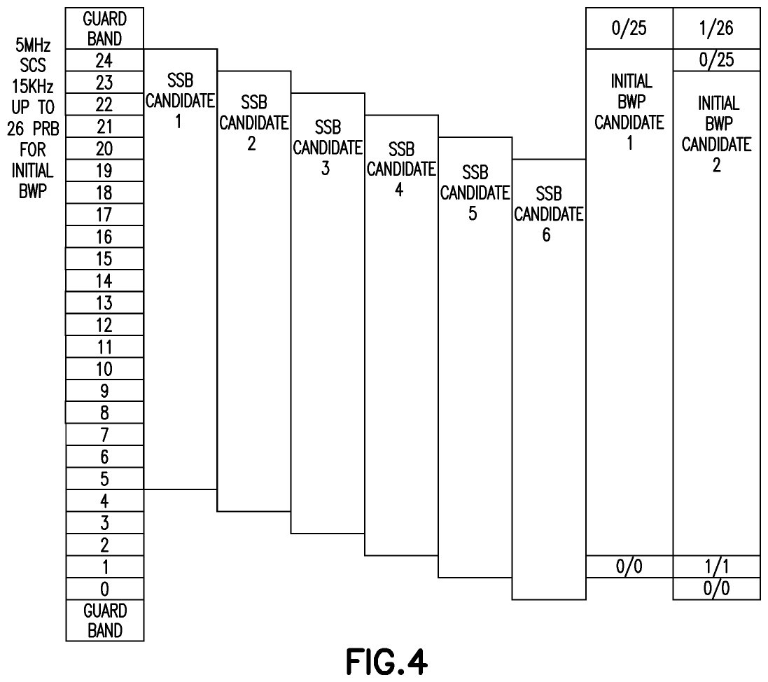

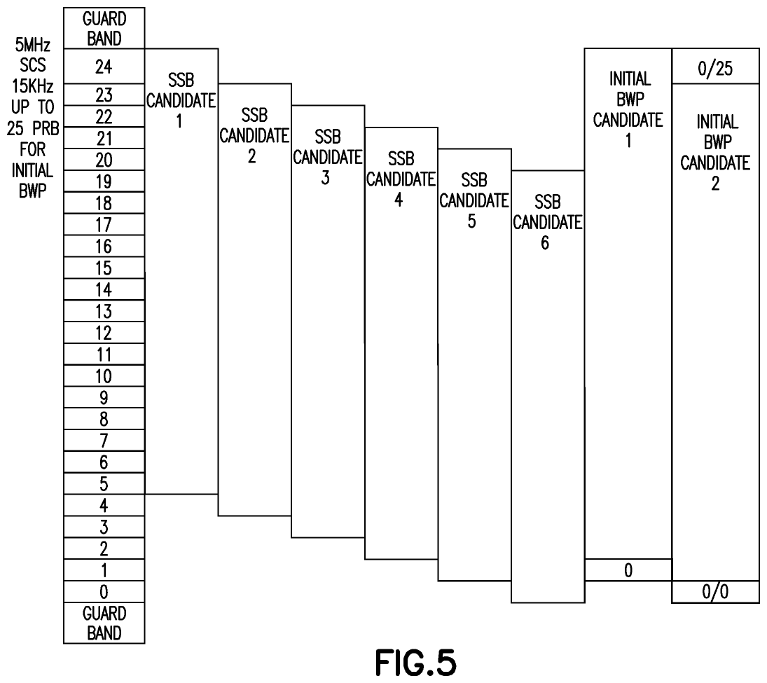

FIG. 4 and FIG. 5 each show one scenario in accordance with example embodiments of the disclosure for enhancement, where FIG. 4 shows extending resource blocks beyond the pre-defined maximum 24 RBs with using a guard band for SIB1, and FIG. 5 shows extending resource blocks beyond the maximum 24 RBs without using guard bands for SIB1, and where as shown in FIG. 4 there is a 5 MHz carrier or bandwidth part using sub carrier space (SCS) at 15 KHz with up to 26 PRBs for initial BWP, where this sub carrier space includes guard bands, SSB candidates 1-6, an initial band-width part (BWP) candidate1 expanding the number of resource blocks 0/25 and an initial BWP candidate2 expanding the number of resource blocks 1/26 and 0/25, and where as shown in FIG. 5 there is a 5 MHz carrier or bandwidth part using a sub carrier space (SCS) at 15 KHz with up to 25 PRBs (beyond the pre-defined maximum number of 24 RBs) for the initial BWP, where this sub carrier space includes guard bands on both ends of the resource blocks, SSB candidates 1-6, an initial band-width part (BWP) candidate1 and an initial BWP candidate2 extending beyond the pre-defined maximum to the number of resource blocks 0/25.

In accordance with Scenario A (see FIG. 4), the method extending RBs using guard bands may include exemplary steps including:
1) REDCAP UE performs normal DL search cell and synchronization using the SSB, decodes the Master Information Broadcast (MIB), and acquires CORESET 0 (i.e., CORESET ID 0 or CORESET #0) configuration from the decoded MIB.
2) CORESET 0 DCI (downlink control information) with system information-radio network temporary identifier (SI-RNTI) indicates the SIB1 PD SCH frequency domain resource assignment is 47, that mean all initial BWP RB (24 RBs may be used for PDSCH, calculate based on standards at the time of this application Downlink resource allocation type 1.
   A downlink type 1 resource allocation field may consist of resource indication value (RIV) corresponding to a starting virtual resource block (RBstart) and a length in terms of contiguously allocated resource blocks (LRBs). The resource indication value is defined by:

$$if ( {L}_{RBs} - 1 ) \leq ⌊ {N}_{BWP}^{size} / 2 ⌋$$

$$then$$

$$RIV = {N}_{BWP}^{size} ( {L}_{RBs} - 1 ) + {RB}_{start}$$

$$else$$

$$RIV = {N}_{BWP}^{size} ( {N}_{BWP}^{size} - {L}_{RBs} + 1 ) + ( {N}_{BWP}^{size} - 1 - {RB}_{start} )$$

$$where$$

$${L}_{RBs} \geq 1 and shall not exceed {N}_{BWP}^{size} - {RB}_{start} .$$

3) If initial BWP is 24 RBs and the RIV is 47 (The example in FIG. 4 assumes that L_RBs=24 and RB_start=0), then, RIV=24*(24−24+1)+(24−1−0)=47. If the system BW is 5 MHz, REDCAP UE should assume the number of scheduled RB being beyond the pre-defined maximum, i.e., larger than 24, (e.g., 25 RBs or 26 RBs as in FIG. 4). If the system BW is >5 MHz, then REDCAP UE assumes the number of scheduled RB is as indicated by the RIV (i.e., 24 RBs in case of RIV=47). In another embodiment, the RB extension may not be known to the UE (i.e., based on gNB implementation) and UE may perform decoding with and without using the extended or additional RBs. The extension may be done via repetition of the resource blocks or by rate-matching of the data into the additional resource blocks.
4) The SIB1 PDSCH DMRS reference point for k is subcarrier 0 of the lowest-numbered resource block in CORESET 0, if the corresponding PDCCH is associated with CORESET 0 and Type0-PDCCH common search space and is addressed to SI-RNTI. The extended RB assumed may be from 24, that may not be smaller than 0. This assumption of the RB position may be bigger than 24. This may be shown with:

$${a}_{k , l}^{( p , μ )} = {β}_{PDSCH}^{DMRS} {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

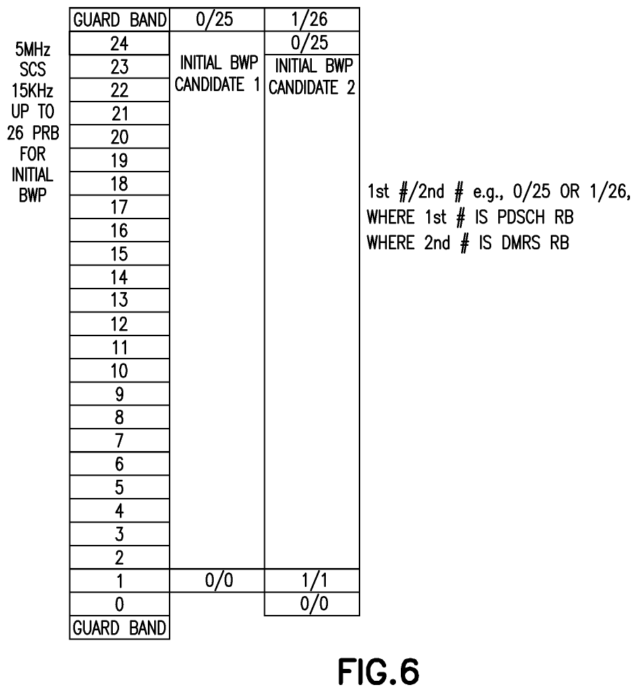

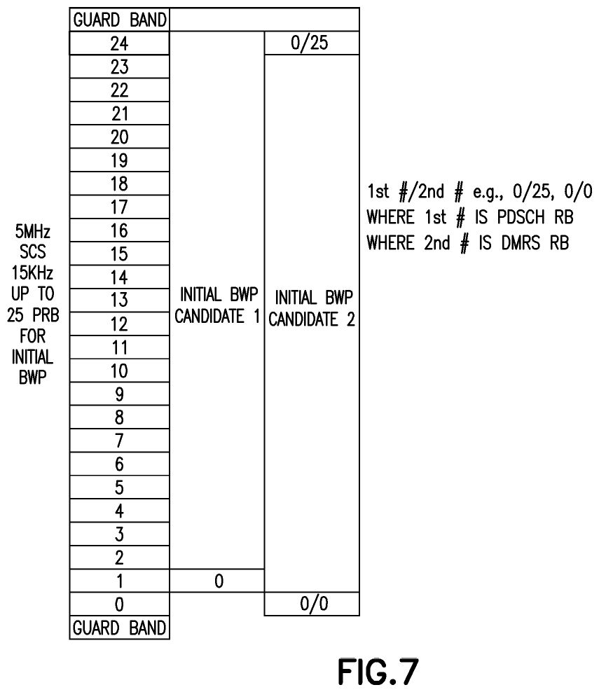

5) The extended 25th RB (the 26th RB is in guard band) or 25th, and 26th RBs (the 26th RB is in guard band) data as shown in FIG. 6,
   FIG. 6 shows extended RB content in accordance with example embodiments of the disclosure that is same with RB0 and 1, where as shown in FIG. 6 there is a 5 MHz sub carrier space (SCS) at 15 KHz with up to 26 PRB for initial BWP, where this sub carrier space includes a 24 resource block guard band, an initial band-width part (BWP) candidate1 and an initial BWP candidate2 expanding the number of resource blocks 0/25, then as shown in FIG. 7 the data is repeated or copied to the starting resource block RB0 or RB 0,1 PDSCH data part, but a demodulation reference signal (DMRS) uses RB 25 and 26 sequence:
a. The RBs to be repeated are selected from a start at one end of the number of scheduled resource blocks of the system information broadcast message in a wrap-around manner as shown in FIG. 6. In accordance with example embodiments of the invention this start and the number of scheduled resource blocks can be pre-configured or pre-determined,
b. In another embodiment, the DMRS sequence is not changed in the extended RBs. This will allow the UE to directly combine the extended RBs including the DMRS, and
c. Note in case RB extension is an optional feature, the UE may check for presence of DMRS matching in the extended PRBs prior to combining the extra RBs.
6) There is no impact to non-REDCAP UE, that is, UE receives the same transport block size (TBS) and DCI indicate and rate-matched in un-extended 24 RBs physical downlink shared channel for non-REDCAP UE. But REDCAP UE may still assume to receive and decode the extended RBs for enhancement DL coverage.

In the aforementioned solution, one side of guard band (i.e., the most top RB assigned to a guard band) may be used to extend the number of RBs for SIB1 of a target REDCAP UE.

In accordance with Scenario B (see FIG. 5), the method extending RBs without guard band for SIB1 may include steps as follows:
1) same with scenario A's step 1,
2) same with scenario A's step 2,
3) same with scenario A's step 3,
4) same with scenario A's step 4,
5) The extended 25th RB (that is not located in guard band) data in FIG. 6 may be repeated or copied to the RB0 PDSCH data part, but DMRS (demodulation reference signal) may use RB 25 sequence, and
6) same with scenario A's step 6.

FIG. 7 shows extended RB content in accordance with example embodiments of the disclosure that is same with RB0, where: FIG. 7 shows a diagram of 5 MHz sub carrier space (SCS) 15 KHz up to 25 PRB for initial BWP, where as shown in FIG. 7 for a 5 MHz SCS 15 KHz up to 25 PRB For Initial Bandwidth Part this sub carrier space includes a 24 resource block guard band, an initial calculated band-width part (BWP) for candidate1 used for PUSCH and an initial BWP candidate2 expanding the number of resource blocks to 25 thereby enhancing downlink coverage for a REDCAP user device.

Note that this method may also be used to extend the PBCH (Physical Broadcast Channel) in the SSB. In the case of 5 MHz system bandwidth, there would be 5 extra RBs that may remain empty when the SSB is transmitted. The same approach as in scenarios A or scenario B as described above may be used for the PBCH as well to provide coverage enhancement. In case of PBCH, the UE may perform blind decoding to detect the presence of additional PBCH extension.

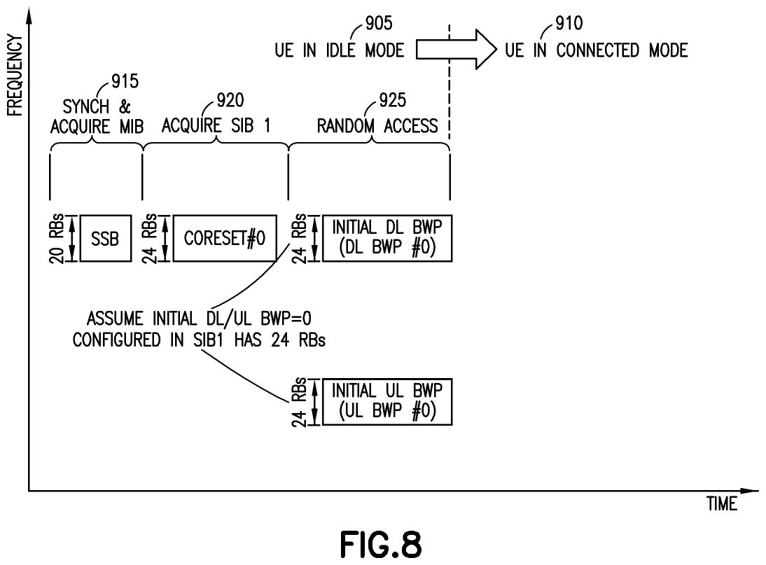

FIG. 8 shows one proposed system diagram in accordance with example embodiments as illustrated in FIG. 4 and FIG. 5. FIG. 8 shows at step 905 a UE in idle mode transitioning to 910 UE in connected mode. As shown in FIG. 8, while in the idle mode there is at step 915 synchronization and acquiring master information broadcast (MIB). This step may use 20 resource blocks with a synchronization signal block (SSB). As shown in step 920 of FIG. 8 there is acquiring a system information broadcast. This step uses 24 resource blocks with a control resource set (CORESET 0). Then as shown in step 925 there is random access. This step uses 24 resource blocks with an initial downlink bandwidth part e.g., #0. Then assuming the initial DL/UL bandwidth part #0 configured in system information broadcast (SIB) 1 has 24 resource blocks there is 24 resource blocks for initial uplink (UL) bandwidth part (BWP) #0.

FIG. 10A illustrates operations which may be performed by a device such as, but not limited to, a terminal device (e.g., the UE 10 as in FIG. 9). As shown in step 1010 of FIG. 10A there is receiving, by a terminal device and from a network node of a radio access network, control information for a physical downlink shared channel (PDSCH) message or transmission. As shown in step 1020 of FIG. 10A wherein the control information indicates if a number of resource blocks scheduled by the network node for the physical downlink shared channel message or transmission is extendable in a frequency domain. Then as shown in step 1030 of FIG. 10A there is receiving the physical downlink shared channel message or transmission based on the control information.

In accordance with the example embodiments as described in the paragraph above, wherein the physical downlink shared channel message or transmission includes a system information broadcast message, and the control information includes a resource indication value indicative of if the number of scheduled resource blocks is extendable in frequency domain.

In accordance with the example embodiments as described in the paragraphs above, wherein the number of scheduled resource blocks is determined based on at least a portion of a system bandwidth or bandwidth part (BWP) configured in the radio access network.

In accordance with the example embodiments as described in the paragraphs above, wherein the number of scheduled resource blocks is extended if the at least the portion of the system bandwidth or bandwidth part is equal to a pre-defined value; and wherein the number of scheduled resource blocks is not extended if the at least the portion of the system bandwidth or bandwidth part is greater than the pre-defined value.

In accordance with the example embodiments as described in the paragraphs above, wherein the pre-defined value for the system bandwidth is 5 MHz or the number of scheduled resource blocks in the bandwidth part is 25 resource blocks.

In accordance with the example embodiments as described in the paragraphs above, wherein the number of scheduled resource blocks is extended beyond the pre-defined value.

In accordance with the example embodiments as described in the paragraphs above, wherein the number of scheduled resource blocks beyond the pre-defined value is extended into a guard band associated with the system bandwidth or bandwidth part.

In accordance with the example embodiments as described in the paragraphs above, wherein the number of scheduled resource blocks beyond the pre-defined value is extended without engaging a guard band associated with the system bandwidth or bandwidth part.

In accordance with the example embodiments as described in the paragraphs above, wherein the extended number of scheduled resource blocks beyond the pre-defined value being one of: data in a repeated and copied resource blocks in the physical downlink shared channel message or a transmission.

In accordance with the example embodiments as described in the paragraphs above, wherein extended resource blocks into the guard band are repeated by selecting from a start at one end of the number of scheduled resource blocks of the system information broadcast message in a wrap-around manner.

In accordance with the example embodiments as described in the paragraphs above, wherein the extended number of scheduled resource blocks include a demodulation reference signal sequence associated with the system information broadcast message to allow the terminal device to directly combine with the extended resource blocks.

In accordance with the example embodiments as described in the paragraphs above, wherein the extended number of scheduled resource blocks comprise a demodulation reference signal sequence associated with the system information broadcast message to allow the terminal device to directly combine with the extended resource blocks.

In accordance with the example embodiments as described in the paragraphs above, there is when the extended resource blocks engaged in the guard band, checking for presence of a demodulation reference signal matching in the extended resource blocks prior to the combining of the extended resource blocks, wherein the demodulation reference signal is associated with the system information broadcast message.

In accordance with the example embodiments as described in the paragraphs above, wherein the demodulation reference signal is used with at least one of the extended resource blocks without engaging the guard band.

A non-transitory computer-readable medium (MEM 10B as in FIG. 9) storing program code (PROG 10C as in FIG. 9), the program code executed by at least one processor (DP 10A as in FIG. 9) to perform the operations as at least described in the paragraphs above.

In accordance with an example embodiment of the disclosure as described above there is an apparatus includes: means for receiving (TRANS 10D, MEM 10B, PROG 10C, and DP 10A as in FIG. 9), by a terminal device (UE 10 as in FIG. 9) and from a network node (NN 12 and/or NN 13 as in FIG. 9) of a radio access network, control information for a physical downlink shared channel (PDSCH) message or transmission, wherein the control information indicates (TRANS 10D, MEM 10B, PROG 10C, and DP 10A as in FIG. 9) if a number of resource blocks scheduled by the network node for the physical downlink shared channel message or transmission is extendable in a frequency domain; and means for receiving (TRANS 10D, MEM 10B, PROG 10C, and DP 10A as in FIG. 9) the physical downlink shared channel message or transmission based on the control information.

In the example aspect of the disclosure according to the paragraph above, wherein at least the means for receiving and indicating includes a non-transitory computer readable medium [MEM 10B as in FIG. 9] encoded with a computer program [PROG 10C as in FIG. 9] executable by at least one processor [DP 10A as in FIG. 9].

FIG. 10B illustrates operations which may be performed by a network device such as, but not limited to, a network node NN 12 and/or NN 13 as in FIG. 9 or an eNB or gNB. As shown in step 1050 of FIG. 10B there is determining, by a network node of a radio access network, control information for a physical downlink shared channel (PDSCH) message or transmission to a terminal device. As shown in step 1060 of FIG. 10B wherein the control information indicates if a number of resource blocks scheduled by the network node for the physical downlink shared channel message or transmission is extendable in a frequency domain. Then as shown in step 1070 of FIG. 10B there is sending the physical downlink shared channel message or transmission to the terminal device based on the control information.

In accordance with the example embodiments as described in the paragraph above, wherein the physical downlink shared channel message or transmission comprises a system information broadcast message, and the control information includes a resource indication value indicative of if the number of scheduled resource blocks is extendable in frequency domain.

In accordance with the example embodiments as described in the paragraphs above, wherein the number of scheduled resource blocks is determined based on at least a portion of a system bandwidth or bandwidth part (BWP) configured in the radio access network.

In accordance with the example embodiments as described in the paragraphs above, wherein the number of scheduled resource blocks is extended if the at least the portion of the system bandwidth or bandwidth part is equal to a pre-defined value; and wherein the number of scheduled resource blocks is not extended if the at least the portion of the system bandwidth or bandwidth part is greater than the pre-defined value.

In accordance with the example embodiments as described in the paragraphs above, wherein the pre-defined value for the system bandwidth is 5 MHz or the number of scheduled resource blocks in the bandwidth part is 25 resource blocks.

In accordance with the example embodiments as described in the paragraphs above, wherein the number of scheduled resource blocks is extended beyond the pre-defined value.

In accordance with the example embodiments as described in the paragraphs above, wherein the number of scheduled resource blocks beyond the pre-defined value extended into a guard band associated with the system bandwidth or bandwidth part.

In accordance with the example embodiments as described in the paragraphs above, wherein the number of scheduled resource blocks extended beyond the pre-defined value is extended without engaging a guard band associated with the system information block message.

In accordance with the example embodiments as described in the paragraphs above, wherein the extended number of scheduled resource blocks beyond the predefined value is being one of: data in a repeated or and copied resource blocks from within the physical downlink shared channel data part message or transmission.

A non-transitory computer-readable medium (MEM 12B and/or MEM 13B as in FIG. 9) storing program code (PROG 12C and/or PROG 13C as in FIG. 9), the program code executed by at least one processor (DP 12A and/or DP 13A as in FIG. 9) to perform the operations as at least described in the paragraphs above.

In accordance with an example embodiment of the disclosure as described above there is an apparatus includes: means for determining (TRANS 12D and/or TRANS 13D, MEM 12B and/or MEM 13B, PROG 12C and/or PROG 13C, and DP 12A and/or DP 13A as in FIG. 9), by a network node (NN 12 and/or NN 13 as in FIG. 9) of a radio access network, control information for a physical downlink shared channel (PDSCH) message or transmission to a terminal device, wherein the control information indicates (TRANS 12D and/or TRANS 13D, MEM 12B and/or MEM 13B, PROG 12C and/or PROG 13C, and DP 12A and/or DP 13A as in FIG. 9) if a number of resource blocks scheduled by the network node for the physical downlink shared channel message or transmission is extendable in a frequency domain; and means for sending (TRANS 12D and/or TRANS 13D, MEM 12B and/or MEM 13B, PROG 12C and/or PROG 13C, and DP 12A and/or DP 13A as in FIG. 9) the system information broadcast message to the terminal device based on the control information.

In the example aspect of the disclosure according to the paragraph above, wherein at least the means for determining, indicating, and sending includes a non-transitory computer readable medium [MEM 12B and/or MEM 13B as in FIG. 9] encoded with a computer program [PROG 12C and/or PROG 13C as in FIG. 9] executable by at least one processor [DP 12A and/or DP 13A as in FIG. 9].

It is noted that advantages of example embodiments of the disclosure as described herein include a compatibility with previous 3GPP versions and will not affect non-REDCAP UEs, the coverage of downlink for standards based 5 MHz REDCAP UE is increased, and a utilization rate of PRB is improved.

In accordance with example embodiments of the disclosure as disclosed in this application this application, the “circuitry” provided may include at least one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions, such as functions or operations in accordance with example embodiments of the disclosure as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the disclosure, there is adequate circuitry for performing at least novel operations as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable):
   (i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the disclosures may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the disclosure and not to limit the scope of the disclosure which is defined by the claims.

The foregoing description has provided by way of exemplary and non-limiting examples a full and informative description of the best method and apparatus presently contemplated by the inventors for carrying out the disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this disclosure.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements may be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this disclosure could be used to advantage without the corresponding use of other features. As such, the foregoing description should be considered as merely illustrative of the principles of the disclosure, and not in limitation thereof.

1-49. (canceled)

50. An apparatus, comprising:
at least one processor; and
at least one non-transitory memory including computer program code, wherein the at least one non-transitory memory and the computer program code are configured, with the at least one processor, to cause the apparatus to at least:
receive, by a terminal device and from a network node of a radio access network, control information for a physical downlink shared channel (PDSCH) message or transmission, wherein the control information indicates if a number of resource blocks scheduled by the network node for the physical downlink shared channel message is extendable in frequency domain; and
receive the physical downlink shared channel message or transmission based on the control information.

51. The apparatus according to claim 50, wherein the physical downlink shared channel message or transmission comprises a resource indication value indictive of if the number of scheduled resource blocks is extendable in the frequency domain.

52. The apparatus according to claim 51, wherein the number of scheduled resource blocks is determined based on at least a portion of a system bandwidth or bandwidth part (BWP) configured in the radio access network.

53. The apparatus according to claim 51, wherein the number of scheduled resource blocks is extended if the at least the portion of the system bandwidth or bandwidth part is equal to a pre-defined value; and
wherein the number of scheduled resource blocks is not extended if the at least the portion of the system bandwidth or bandwidth part is greater than the pre-defined value.

54. The apparatus according to claim 53, wherein the pre-defined value for the system bandwidth is 5 MHz or the number of scheduled resource blocks in the bandwidth part is 25 resource blocks.

55. The apparatus according to claim 53, wherein the number of scheduled resource blocks is extended beyond the pre-defined value.

56. The apparatus according to claim 55, wherein the number of scheduled resource blocks beyond the pre-defined value is extended into a guard band associated with the system bandwidth or bandwidth part.

57. The apparatus according to claim 56, wherein the number of scheduled resource blocks beyond the predefined value is extended without engaging a guard band associated with the system bandwidth or BWP.

58. The apparatus of claim 57, wherein the extended number of scheduled resource blocks beyond the predefined value being one of: data in a repeated and copied resource blocks in the physical downlink shared channel message or transmission.

59. The apparatus of claim 56, wherein extended resource blocks into the guard band are repeated by selecting from a start at one end of the number of scheduled resource blocks of the system information broadcast message in a wrap-around manner.

60. The apparatus of claim 59, wherein the extended number of scheduled resource blocks comprise a demodulation reference signal sequence associated with the system information broadcast message to allow the terminal device to directly combine with the extended resource blocks.

61. The apparatus of claim 59, wherein when the extended resource blocks engaged in the guard band, the terminal device checks for presence of a demodulation reference signal matching in the extended resource blocks prior to the combining of the extended resource blocks, wherein the demodulation reference signal is associated with the system information broadcast message.

62. The apparatus of claim 60, wherein the demodulation reference signal is used with at least one of the extended resource blocks without engaging the guard band.

63. An apparatus, comprising:
at least one processor; and
at least one non-transitory memory including computer program code, where the at least one non-transitory memory and the computer program code are configured, with the at least one processor, to cause the apparatus to at least:
determine, by a network node of a radio access network, control information for a physical downlink shared channel (PDSCH) message or transmission to a system information broadcast message for transmission to a terminal device, wherein the control information indicates if a number of resource blocks scheduled by the network node for the physical downlink shared channel message or transmission is extendable in a frequency domain; and
send the physical downlink shared channel message or transmission to the terminal device based on the control information.

64. The apparatus according to claim 63, wherein the physical downlink shared channel message or transmission comprises a resource indication value indicative of if the number of scheduled resource blocks is extendable in frequency domain.

65. The apparatus according to claim 64, wherein the number of scheduled resource blocks is determined based on at least a portion of a system bandwidth or bandwidth part configured in the radio access network.

66. The apparatus according to any one of claim 64, wherein the number of scheduled resource blocks is extended if the at least the portion of the system bandwidth or bandwidth part is equal to a pre-defined value; and
wherein the number of scheduled resource blocks is not extended if the at least the portion of the system bandwidth or bandwidth part is greater than the pre-defined value.

67. The apparatus according to claim 66, wherein the pre-defined value is 5 MHz or the number of scheduled resource blocks in the bandwidth part is 25 resource blocks.

68. The apparatus according to claim 66, wherein the number of scheduled resource blocks is extended beyond the pre-defined value.

69. The apparatus according to claim 68, wherein the number of scheduled resource blocks beyond the pre-defined value extended into a guard band associated with the system bandwidth or bandwidth part.
